(19) United States
(12) Patent Application Publication
(10) Pub. No.: US 2020/0183952 A1
(43) Pub. Date: Jun. 11, 2020

(54) NUMERICAL INFORMATION MANAGEMENT DEVICE USING DATA STRUCTURE

(71) Applicant: Hoon KIM, Daejeon (KR)

(72) Inventor: Hoon KIM, Daejeon (KR)

(21) Appl. No.: 16/480,648

(22) PCT Filed: Jan. 4, 2018
(86) PCT No.: PCT/KR2018/000184

§ 371 Date: Sep. 23, 2019

(30) Foreign Application Priority Data
Jan. 24, 2017 (KR) 10-2017-0011299

(51) Int. Cl. G06F 16/28; G06F 16/904; G06F 16/907; G06F 16/25; G06F 16/9537; G06F 16/2457; G06F 16/22

(52) U.S. Cl. CPC G06F 16/283; G06F 16/904; G06F 16/907; G06F 16/22; G06F 16/9537; G06F 16/2457; G06F 16/25

(57) ABSTRACT

The present invention relates to a numerical information management device which converts numerical information into cube data having numerical values using a single data structure and metadata for analyzing the cube data and stores and manages the converted numerical information. More particularly, the present invention relates to a numerical information management device using a data structure comprising: a data structure unit which converts numerical information into cube data including numerical values and metadata for analyzing the cube data when the numerical information is input; a DB which separately stores the converted cube data and metadata, and at least one graph template; and a content providing unit which extracts metadata corresponding to a search keyword and extracts and analyzes the corresponding cube data using the extracted metadata to provide a graph for the numerical information.

### TECHNICAL FIELD

The present invention relates to a numerical information management device which converts numerical information into cube data having numerical values using a single data structure and metadata for analyzing the cube data and stores and manages the converted numerical information.

### BACKGROUND ART

A variety of information is formed socially or personally by human activities. At this time, a variety of information may be information related to texts, images, numerical values (figures), and the like.

Meanwhile, users have apply these information to research and development, decision making, etc. by utilizing statistics of such information. Therefore, the collection, accumulation, search and use of information depending on advanced science and technology may be one of indispensable acts in human intellectual activities in information society.

To this end, various resource management devices are disclosed. Korean Patent Registration No. 10-0535373 relates to an information search management system, and there are difficulties to searching, determining of relationship, and utilization of numerical information merely by providing and managing information including a keyword through general keyword search.

Accordingly, there is a need for a numerical information management device capable of searching or utilizing numerical information in accordance with a user's purpose and providing numerical information in an appropriate graph form to be determined at a glance.

### DISCLOSURE

### Technical Problem

An object of the present invention is to provide a numerical information management device using a data structure capable of easily storing and providing data by structuring and managing numerical in a single data structure.

Another object of the present invention is to provide a numerical information management device using a data structure capable of performing data processing such as correction, division, deletion, extension, and merging by defining cube data in set row units.

Yet another object of the present invention is to provide a numerical information management device using a data structure capable of providing numerical information in a graph.

### Technical Solution

In order to achieve the objects, an exemplary embodiment of the present invention provides a numerical information management device using a data structure comprising: a data structure unit which converts numerical information into cube data including numerical values and metadata for analyzing the cube data when the numerical information is input; a DB which separately store the converted cube data and metadata, and at least one graph template; and a content providing unit which extracts metadata corresponding to a search keyword and extracts and analyzes the corresponding cube data using the extracted metadata to provide a graph for the numerical information.

The cube data may have a set row structure including a temporal viewpoint for recording time information, a spatial viewpoint for recording spatial information, a user viewpoint for recording information other than the time information and the space information, and a numerical value, and the data structure unit may extract at least one of the temporal viewpoint, the spatial viewpoint, and the user viewpoint and a numerical value from the input numerical information and record the viewpoint and the numerical value in a corresponding area to generate the cube data and stores the generated cube data in the DB by a file unit.

The cube data may be configured by at least one set row forming a file.

In addition, the temporal viewpoint, the spatial viewpoint and the user viewpoint of the cube data may be divided into a plurality of viewpoints, and the plurality of viewpoints may be hierarchically divided into a higher concept and at least one lower concept depending on the higher concept, and each viewpoint may have a hierarchical name according to a hierarchical position.

When the cube data download for the provided graph is requested, the content providing unit may provide the corresponding cube data as one of an Excel file and a Text file and the provided cube data may include only valid data from which null data is removed.

The metadata may include file index information, a column name, analysis information, and management information corresponding to the corresponding cube data, and the DB may store information included in the metadata in the form of a relational table, the column name may be defined by a hierarchical name order of each viewpoint included in the corresponding cube data, and the analysis information may include at least one of unit information for representing a numerical value included in the input numerical information, graph template information, hierarchical column names, language, and the like.

The hierarchical name in the temporal viewpoint may be tn, a hierarchical name in the spatial viewpoint may be ln, a hierarchical name in the user viewpoint may be Un, and n may be a hierarchical level.

The graph template information may be a special-use graph or a general graph, and the content providing unit may analyze cube data by a predetermined analysis method according to a special use if the graph template information is the special-use graph, wherein the special use may be one of map coordinates, baduk, game records genealogy, time tables, body management tables, and molecular formulas.

The numerical information management device may further comprise a content processing unit which performs at least one of correction, division, deletion, extension, and merging by a set row unit of the cube data, wherein the content processing unit may perform the merging in a set row unit for at least two pieces of cube data in which unit information of the metadata is matched, and perform extension in a set row unit for at least two pieces of cube data in which at least one of the hierarchical column names of the metadata is matched.

The content providing unit may include a metadata extracting unit which extracts metadata including a hierarchical column name corresponding to the search keyword; a cube data extracting unit which extracts the corresponding cube data using the file index information and the column name of the extracted metadata; and a graph providing unit which analyzes the extracted cube data using the analysis information of the extracted metadata and extracts a graph template corresponding to the analyzed cube data to provide a graph of the search keyword.

The inputted numerical information may be information having a numerical value input by a user interface or information having a numerical value collected in the Internet and a designated local network using a bot, and when the numerical information is input through the user interface, the content providing unit may generate and provide a graph for the inputted numerical information using the cube data and metadata converted by the data structure unit.

The numerical information management device may further comprise a content sharing unit which provides the graph provided by the content providing unit through a user-specified social network services/sites (SNS), a link URL, and a download.

The content providing unit may extract a graph template designated by the user or a recommended graph template from the DB and apply and provide the analyzed cube data to the extracted graph template.

The content providing unit may include a graph recommending unit which recommends a graph template according to the information recorded in the temporal viewpoint, the spatial viewpoint, and the user viewpoint of the extracted cube data or a unit of the numerical value.

### Advantageous Effects

As described above, according to the present invention, the numerical information management device using the data structure of the present invention structures and manages numerical information into a single data structure, thereby facilitating data storage and provision.

Further, it is possible to perform data processing such as modification, split, delete, expand and merge by defining cube data in set row units.

In addition, a search result is schematized and provided in a graph to be easily determined by a user at a glance.

In addition, it is possible to enhance data security by separately storing cube data including numerical values and metadata analyzing the cube data.

Further, it is possible to provide a graph reflecting numerical information characteristics by recommending and providing an appropriate graph template base on a viewpoint of cube data.

Further, it is possible to utilize data by downloading a graph for numerical information or sharing the graph for numerical information through SNS, link URLs, etc.

Further, there is no need to re-prepare a calling query even if changes are made to the cube data by defining column names of cube data in a hierarchical name order, storing the column names in the metadata, and extracting the cube data by calling through a query or the like using the column names.

### DESCRIPTION OF DRAWINGS

FIG. 1 is a block diagram illustrating a configuration of a numerical information management device using a data structure according to an exemplary embodiment of the present invention.

FIG. 2 is a block diagram illustrating a configuration of a content providing unit of FIG. 1.

FIG. 3 is a diagram for describing a structure of cube data according to an exemplary embodiment of the present invention.

FIG. 4 is a diagram illustrating numerical information.

FIGS. 5 and 6 are diagrams illustrating cube data according to various embodiments of the present invention.

FIG. 7 is a diagram for describing special-use cube data according to an exemplary embodiment of the present invention.

FIG. 8 is a diagram for describing metadata according to an exemplary embodiment of the present invention.

FIG. 9 is a graph for FIG. 4.

FIG. 10 is a special graph corresponding to special-use numerical information of FIG. 7.

### MODES OF THE INVENTION

Terms and words used in the present specification and claims should not be interpreted as being limited to typical or dictionary meanings, but should be interpreted as having meanings and concepts which comply with the technical spirit of the present disclosure, based on the principle that an inventor can appropriately define the concept of the term to describe his/her own invention in the best manner.

Therefore, the exemplary embodiments described in the present specification and the configurations illustrated in the drawings are merely the most preferred embodiment of the present invention and are not intended to represent all of the technical ideas of the present invention, and thus, it should be understood that various equivalents and modifications capable of replacing the exemplary embodiments at the time of this application.

Hereinafter, before describing the present invention with reference to the drawings, in order to reveal the gist of the present invention, it is to be understood that unnecessary matters, that is, known configurations that can be easily added by those skilled in the art are not illustrated or not specifically described.

A numerical information management device using a data structure of the present invention may structure various numerical information formed in a society into a predetermined database structure to make a DB and provide numerical information in a graphical form in accordance with a user's request. Accordingly, the user may easily determine the numerical information at a glance, and also process and use data according to the purpose of the user.

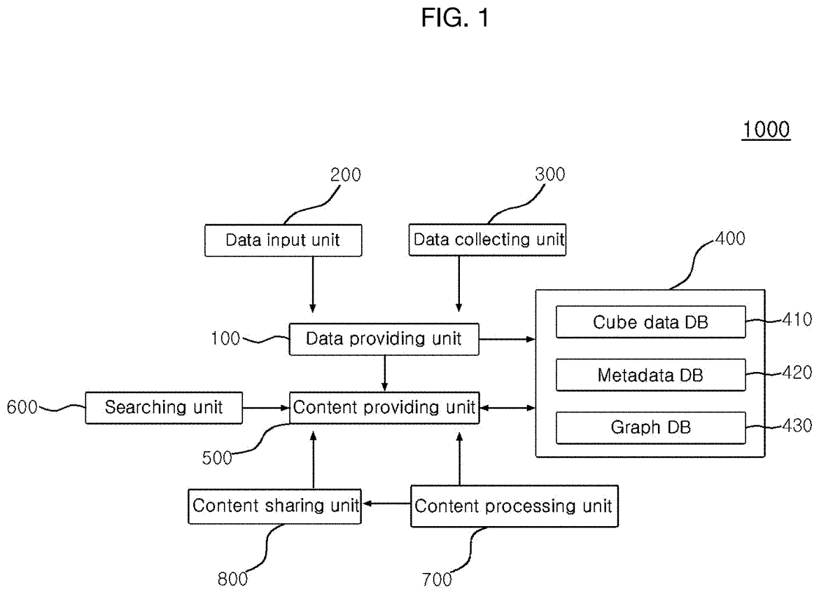

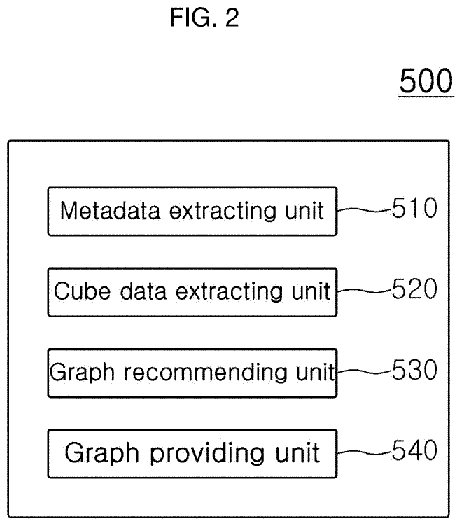

FIG. 1 is a block diagram illustrating a configuration of a numerical information management device using a data structure according to an exemplary embodiment of the present invention. FIG. 2 is a block diagram illustrating a configuration of a content providing unit of FIG. 1.

Referring to FIG. 1, a numerical information management device 1000 using a data structure (hereinafter, referred to as a numerical information management device) according to an exemplary embodiment of the present invention may include a data structure unit 100, a data input unit 200, a data collecting unit 300, a DB 400, a content providing unit 500, a searching unit 600, a content processing unit 700, and a content sharing unit 800.

Referring to FIG. 2, the content providing unit 500 may include a metadata extracting unit 510, a cube data extracting unit 520, a graph recommending unit 530, and a graph providing unit 540.

The data structure unit 100 may convert inputted numerical information based on a structured data structure according to an exemplary embodiment of the present invention and store the converted numerical information in the DB 400.

The data input unit 200 may be a user interface for receiving numerical information from a user. At this time, the data input unit 200 may provide a user interface for inputting numerical information based on the data structure. The data input unit 200 may provide the numerical information input by the user to the data structure unit 100.

Meanwhile, the data input unit 200 may separately provide general numerical information and numerical information according to a special use. The special use will be described in FIG. 6.

Further, the data collecting unit 300 may search numerical information existing in an Internet network and a predetermined local network using a bot, collect the numerical information to be searched, and provide the collected numerical information to the data structure unit 100.

Here, the numerical information may be information related to the numerical values (figures) generated in the society and all information generating numerical values (figures) such as grades generated by students studying at school, an amount of card usage generated by an individual, height, weight, the number of objects occurring in nature, sales generated by the company, stock price, the number of customers, and production.

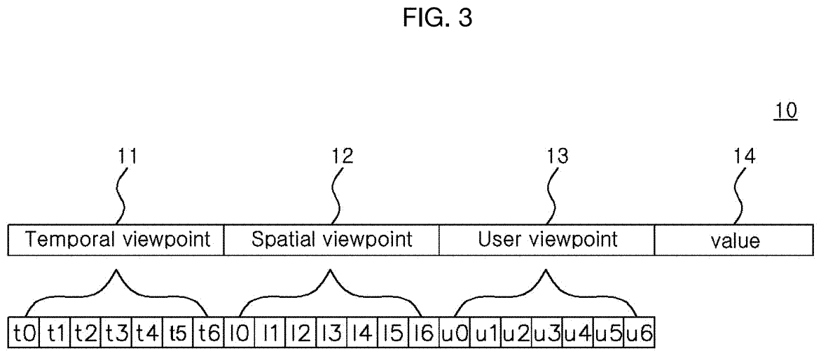

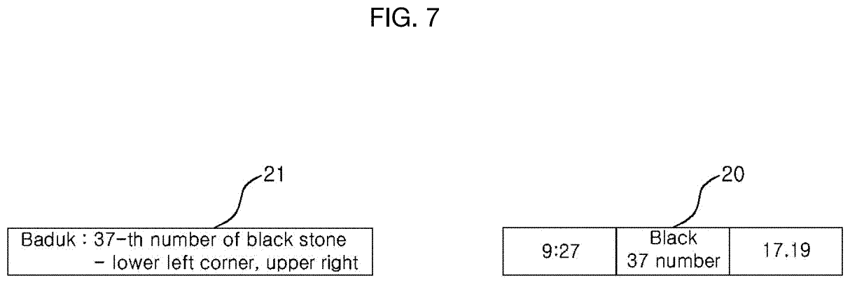

That is, the data structure unit 100 may convert the numerical information into cube data and metadata according to the data structure of the present invention, and store the cube data and the metadata in the DB 400. Here, the cube data is data including numerical values and may have a structure as illustrated in FIG. 3. In addition, the metadata may include information as illustrated in FIG. 8 as data for analyzing the cube data.

FIG. 3 is a diagram for describing a structure of cube data according to an exemplary embodiment of the present invention. Referring to FIG. 3, the cube data structure 10 has a set row structure including a temporal viewpoint l1 (tn) for recording time information, a spatial viewpoint l2 (ln) for recording spatial information, a user viewpoint l3 (Un) for recording information other than the time information and the space information, and a numerical value 14 (value).

In addition, the temporal viewpoint, the spatial viewpoint and the user viewpoint of the cube data are divided into a plurality of viewpoints (hierarchical levels: n), and the plurality of viewpoints are hierarchically divided into a higher concept and at least one lower concept depending on the higher concept, and each viewpoint may have a hierarchical name according to a hierarchical position.

For example, referring to FIG. 3, each viewpoint may be divided into seven hierarchies.

The temporal viewpoint l1 (tn) may be divided into seven hierarchies having hierarchical names t0 to t6. Here, t6 may be defined to mean the sixth hierarchy in terms of temporal viewpoint. In addition, each hierarchy of t0 to t6 may designate the following hierarchical column name. That is, t0 may be the highest concept and t6 may be the lowest concept.

TABLE 1

| t0 | t1 | t2 | t3 | t4 | t5 | t6 |
|---|---|---|---|---|---|---|
| Century | Year | Quarter | Month | Day | Time | User |
| | | | | | | definition |

Further, the spatial viewpoint l2 (In) may be divided into seven hierarchies having hierarchical names l0 to l6. Here, l2 may be defined to mean the second hierarchy in terms of spatial viewpoint. In addition, each hierarchy of l0 to l6 may designate the following hierarchical column name. That is, l0 may be the highest concept and l6 may be the lowest concept.

TABLE 2

| l0 | l1 | l2 | l3 | l4 | l5 | l6 |
|---|---|---|---|---|---|---|
| Continent | Country | Metropolitan | Cities and | Eup/Myeon/Dong | User | User |
| | | city | towns | | definition | definition |

Further, the user viewpoint l3 (Un) may be divided into seven hierarchies having hierarchical names U0 to U6. Here, U1 may be defined to mean the first hierarchy in terms of the user viewpoint. Meanwhile, the user viewpoint Un may be registered by the user at the time of inputting data through the data input unit 200 without designating the hierarchical column name as a basis. In addition, when collected through the data collection unit 300, the data structure unit 100 may apply the collected data using the data of the user viewpoint included in the collected numerical information. On the other hand, the hierarchical column names may be stored in the metadata.

For example, if the numerical information relates to the number of living things, the hierarchical column names may be given as follows.

TABLE 3

| U0 | U1 | U2 | U3 | U4 | U5 | U6 |
|---|---|---|---|---|---|---|
| Phylum | Class | Order | Family | Genus | Species | Subspecies |

Alternatively, if the numerical information relates to the price, the hierarchical column names may be given as follows.

TABLE 4

| U0 | U1 | U2 | U3 | U4 | U5 | U6 |
|---|---|---|---|---|---|---|
| Classification | Classification | Classification | Product | — | — | — |
| of business | of business | of products | names | | | |
| conditions | types | | | | | |

Meanwhile, the cube data has a set row structure to be expanded in a row direction. At this time, the cube data may be configured by a plurality of set rows and the plurality of set rows may form one file. That is, the cube data may be formed for each file.

The data structure unit 100 may extract at least one of the temporal viewpoint l1 (tn), the spatial viewpoint l2 (ln), and the user viewpoint l3 (Un) and the numerical value 14 (value) from the numerical information input by the data input unit 200 and the data collecting unit 300 according to the cube data structure 10 illustrated in FIG. 3 and recode the extracted viewpoint and numerical value in a corresponding area to generate cube data 20. Thus, if the numerical information includes only a temporal viewpoint, the cube data may have only the temporal viewpoint and the numerical value.

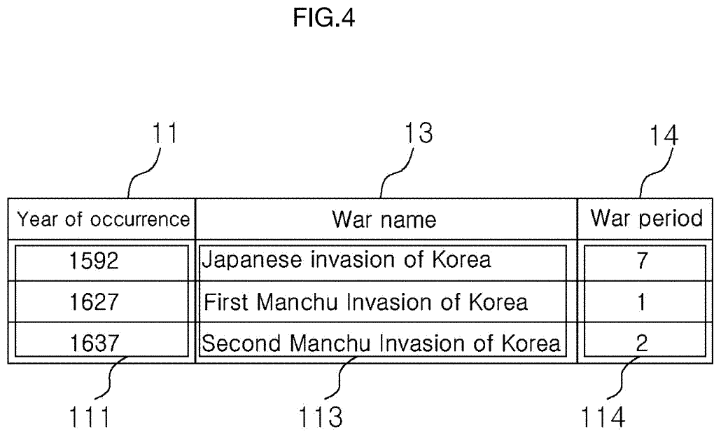

For example, FIG. 4 illustrates numerical information. Meanwhile, the numerical information may be in the form of a graph. The data structure unit 100 recognizes a year of occurrence as the temporal viewpoint l1 (tn), a war name as the spatial viewpoint l3 (Un), a war period as the numerical value 14 (value) from the numerical information of FIG. 4 and determines a hierarchical value 111 of the temporal viewpoint, a hierarchical value 113 of the spatial viewpoint, and a numerical value 114 of each set row to generate the cube data.

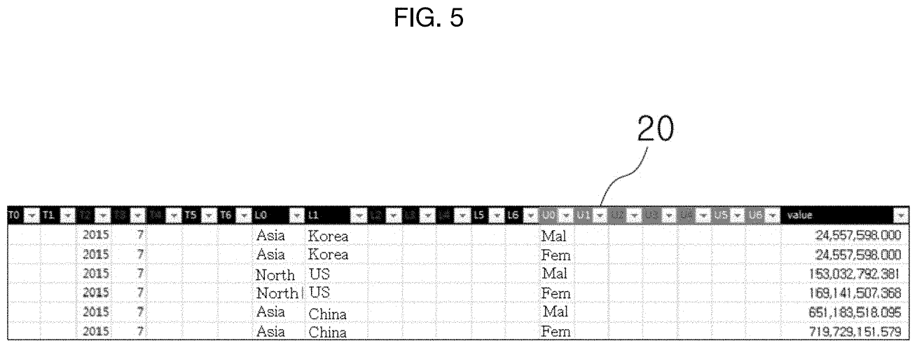

In addition, the data structure unit 100 may store the generated cube data in the cube data DB 410 of the DB 400 in a file unit. On the other hand, the cube data generated in a file unit may have an exemplary embodiment as illustrated in FIGS. 5 and 6.

FIGS. 5 and 6 are diagrams illustrating cube data according to various embodiments of the present invention. Referring to FIG. 5, the cube data 20 is generated from numerical information on ‘the number of male and female population (file) by country in July, 2015’, and includes the number of population as t2 and t3 as hierarchical values for hierarchies of the temporal viewpoint, l0 and l2 as the spatial viewpoint, and U0 and U1 as the user viewpoint and the numerical value for each set row. In this case, the corresponding cube data may have column names of ‘t2, t3, l0, l2, U0, and U1’, and such column name information may be stored in the corresponding metadata.

Alternatively, as illustrated in FIG. 6, when the cube data 20 are generated from numerical information on ‘distance (file) from the sun for each planet’, the cube data may include only a user viewpoint and a numerical value (distance). In this case, the corresponding cube data may have a column name of ‘UO’, and such column name information may be stored in the corresponding metadata.

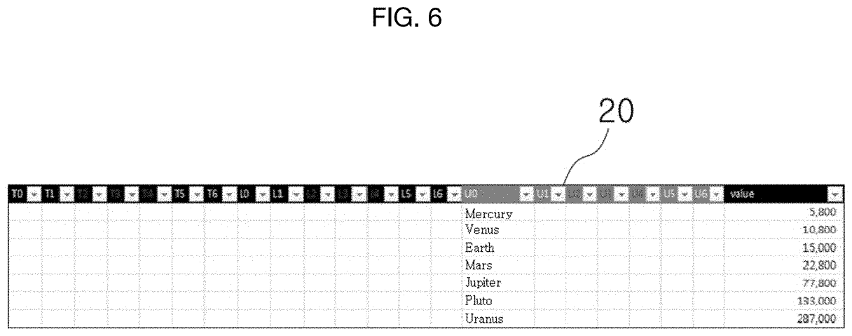

Meanwhile, the data structure unit 100 may generate the cube data 20 from the numerical information for a special use as illustrated in FIG. 7. At this time, the special use may be numerical information prepared for a special-use, such as map coordinates, baduk, game records genealogy, time tables, body management tables, and molecular formulas. That is, unlike general numerical information that may be represented by a general graph, a special graph suitable for a special-use may be required numerical information.

For example, FIG. 7 may illustrate numerical information 21 on the record of baduk and cube data 20 for numerical information. At this time, if a position of the 27th number of black stones is a position of a lower left corner 17 and an upper right corner 19 of the baduk board, the cube data may have a time t5 as the temporal viewpoint, a black or white number UO as the user viewpoint, and a numerical value.

At this time, the numerical value may be recorded by a predetermined method in accordance with the special use. In the case of baduk, the numerical value may be recorded as ‘left reference position—decimal point—right reference position’. Thus, the numerical value becomes 17.19, and the cube data includes a plurality of set rows over time.

Meanwhile, the data structure unit 100 generates cube data based on the data structure from the numerical information and generates metadata for analyzing the generated cube data to store the generated metadata in the metadata DB 420 of the DB 400. At this time, the information included in the metadata may be stored in the form of a relational table. Thus, data security may be enhanced by storing and managing the metadata separately from the cube data.

FIG. 8 is a diagram for describing metadata according to an exemplary embodiment of the present invention. Referring to FIG. 8, the metadata 30 may include file index information 31, a column name 32, analysis information 33, and management information 34 corresponding to the corresponding cube data.

Here, the file index information 31 may be an index value for extracting cube data stored in file units, a file name (graph name), and the like. The column name 32 is defined by a hierarchical name order of each viewpoint included in the corresponding cube data, and if the corresponding cube data includes the temporal viewpoint t1, the user viewpoint UO, and the numerical value (value), a column name of the corresponding cube data may be ‘t1, UO’.

The analysis information 33 is for analyzing a relationship between hierarchies and numerical values included in the cube data and may include at least one of unit information for representing a numerical value included in the input numerical information, graph template information, hierarchical column names, language, and the like.

Here, the unit information may be classified into weights and measures, a reduction unit, and symbols. The weights and measures may be numeric value units such as a weight, a length, a number, and a unit of money. In addition, the reduction unit is a unit for expressing a reduction in the case of a large unit of a numerical value, and for example, if the reduction unit is 10,000 and the numerical value is 1, it may be interpreted as a unit of 10,000. Also, the reduction unit may be used to represent a multiplier. For example, the reduction unit for 10⁶ may be 6. The symbols may be applied when using numerical values such as multiplier, root, and pie.

In addition, the graph template information may be graph template information capable of displaying numerical information according to a special use of the numerical information. In the case of the special use, only a preset number is described, and the analysis method is stored and used separately, thereby reducing the amount of metadata.

Further, the language may be a language name representing each hierarchical value of the cube data.

Meanwhile, the management information 34 is additional information for data management, and may include an owner of the numerical information, a source, the number of using times of the corresponding cube data, an update period, and free-use information according to the use of the information.

The DB 400 may separately store the cube data, the metadata, and the graph template generated by the data structure unit 100.

The cube data DB 410 may store the cube data separately by a file unit.

The metadata DB 420 may store the metadata in the form of a relational table.

The graph template DB 430 stores various graphs, which may be divided into special-use graphs and general graphs.

The content providing unit 500 may extract the metadata corresponding to a search keyword input through the searching unit 600 and extract the corresponding cube data using the extracted metadata. Further, the content providing unit 500 may analyze the corresponding cube data using the information of the extracted metadata to provide a graph. Alternatively, when inputting numerical information by the data input unit 200, the content providing unit 500 may provide a graph using the metadata and the cube data generated by the data structure unit 100.

The metadata extracting unit 510 may extract metadata including a hierarchical column name corresponding to the search keyword.

The cube data extracting unit 520 may extract the corresponding cube data using the file index information and the column name of the extracted metadata.

The graph recommending unit 530 may recommend a graph template according to the information recorded in the temporal viewpoint, the spatial viewpoint, and the user viewpoint of the extracted cube data or recommend a graph template having a high user usage number.

For example, the graph recommending unit 530 may recommend a multi-bar series when there are the temporal viewpoint, the spatial viewpoint, and the user viewpoint, recommend a curved-line series if there is a time dimension, recommend a bar series if there is a space dimension, and recommend a radial series if there is one viewpoint and a hierarchy value is 6 or less.

The graph providing unit 540 may analyze the extracted cube data using the analysis information of the extracted metadata and extract a graph template corresponding to the analyzed cube data to provide a graph of the search keyword. At this time, the recommended graph template of the graph recommending unit 530 may be used or a graph template designated by the user may be used. On the other hand, special graphs may be applied for special uses.

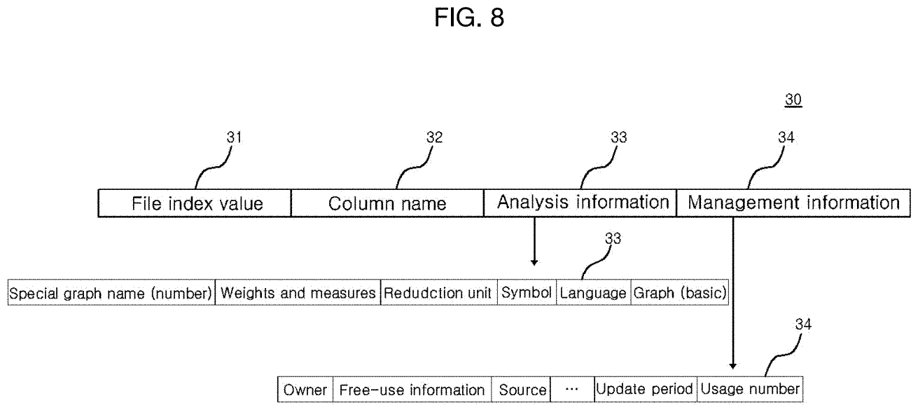

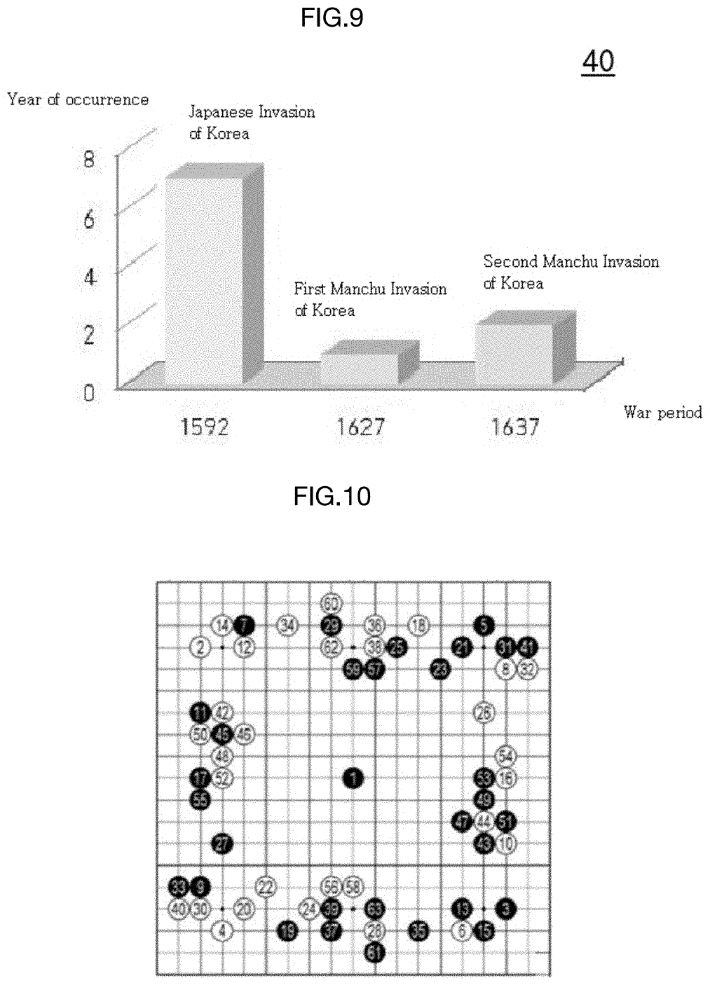

One example of the graph provided by the graph providing unit 540 may be confirmed in FIGS. 9 and 10. FIG. 9 is an example of a graph for FIG. 4. FIG. 10 is a special graph corresponding to special-use numerical information of FIG. 7.

In the case of FIG. 4, when a bar graph is designated by the user, the graph providing unit 540 forms an axis according to each hierarchical column name to provide a graph 40 as illustrated in FIG. 9. In addition, the graph recommending unit 530 may provide a polygonal-line based graph. In addition, the graph providing unit 540 may provide the graph 40 according to the special use as illustrated in FIG. 10 if the metadata has information about the special use.

Meanwhile, when the cube data download for the provided graph is requested, the content providing unit 500 may provide the corresponding cube data as one of an Excel file and a Text file according to the free-use information. At this time, the provided cube data may include only valid data from which null data is removed.

In addition, when data processing is requested by the user, the content providing unit 500 may provide the corresponding cube data to the content processing unit 700. At this time, the data processing may be one of correction, division, deletion, and merging. Thus, collaboration among a plurality of users is possible.

The content processing unit 700 may perform at least one of correction, division, deletion, extension, and merging in a set row unit of the cube data according to a user input. At this time, the merging may be performed in a set row unit for at least two pieces of cube data in which unit information of the metadata is matched, and the extension may be performed in a set row unit for at least two pieces of cube data in which at least one of the hierarchical column names are matched.

At this time, the content providing unit 500 may provide a graph of the cube data processed in the content processing unit 700. For example, if the first cube data relates to the employee number of the company A and the second cube data relates to the sales of the company A, the one-person sales amount of the company A may be estimated and determined through the expanded graph using the first cube data and the second cube data.

The content sharing unit 800 may provide a graph provided by a display unit (not illustrated) in the content providing unit 500 through a user-specified social network services/sites (SNS), a link URL, and a download. Accordingly, the user may share a desired graph using the numerical information or use the graph as utilization data.

Meanwhile, only the main points of the present invention are described above using FIGS. 1 to 10, and it will be apparent that the present invention is limited to the configurations of FIGS. 1 to 10 so long as various designs can be made within the technical scope of the present invention.

1. A numerical information management device using a data structure comprising:
a data structure unit which converts numerical information into cube data including numerical values and metadata for analyzing the cube data when the numerical information is input;
a DB which separately stores the converted cube data and metadata, and at least one graph template; and
a content providing unit which extracts metadata corresponding to a search keyword and extracts and analyzes the corresponding cube data using the extracted metadata to provide a graph for the numerical information.

2. The numerical information management device of claim 1, wherein the cube data has a set row structure including a temporal viewpoint for recording time information, a spatial viewpoint for recording spatial information, a user viewpoint for recording information other than the time information and the space information, and a numerical value, and
the data structure unit extracts at least one of the temporal viewpoint, the spatial viewpoint, and the user viewpoint and a numerical value from the input numerical information and records the viewpoint and the numerical value in a corresponding area to generate the cube data and stores the generated cube data in the DB by a file unit.

3. The numerical information management device of claim 2, wherein the cube data is configured by at least one set row forming a file.

4. The numerical information management device of claim 2, wherein the temporal viewpoint, the spatial viewpoint and the user viewpoint of the cube data are divided into a plurality of viewpoints, and
the plurality of viewpoints are hierarchically divided into a higher concept and at least one lower concept depending on the higher concept, and each viewpoint has a hierarchical name according to a hierarchical position.

5. The numerical information management device of claim 2, wherein when the cube data download for the provided graph is requested, the content providing unit provides the corresponding cube data as one of an Excel file and a Text file and the provided cube data includes only valid data from which null data is removed.

6. The numerical information management device of claim 4, wherein the metadata includes file index information, a column name, analysis information, and management information corresponding to the corresponding cube data, and the DB stores information included in the metadata in the form of a relational table,
the column name is defined by a hierarchical name order of each viewpoint included in the corresponding cube data, and
the analysis information includes at least one of unit information for representing a numerical value included in the input numerical information, graph template information, hierarchical column names, language, and the like.

7. The numerical information management device of claim 6, wherein a hierarchical name in the temporal viewpoint is tn, a hierarchical name in the spatial viewpoint is ln, a hierarchical name in the user viewpoint is Un, and n is a hierarchical level.

8. The numerical information management device of claim 6, wherein the graph template information is a special-use graph or a general graph, and
the content providing unit analyzes cube data by a predetermined analysis method according to a special use if the graph template information is the special-use graph,
wherein the special use is one of map coordinates, baduk, game records genealogy, time tables, body management tables, and molecular formulas.

9. The numerical information management device of claim 6, further comprising:
a content processing unit which performs at least one of correction, division, deletion, extension, and merging by a set row unit of the cube data,
wherein the content processing unit performs the merging in a set row unit for at least two pieces of cube data in which unit information of the metadata is matched, and performs extension in a set row unit for at least two pieces of cube data in which at least one of the hierarchical column names of the metadata is matched.

10. The numerical information management device of claim 6, wherein the content providing unit includes:
a metadata extracting unit which extracts metadata including a hierarchical column name corresponding to the search keyword;
a cube data extracting unit which extracts the corresponding cube data using the file index information and the column name of the extracted metadata; and
a graph providing unit which analyzes the extracted cube data using the analysis information of the extracted metadata and extracts a graph template corresponding to the analyzed cube data to provide a graph of the search keyword.

11. The numerical information management device of claim 1, wherein the inputted numerical information is information having a numerical value input by a user interface or information having a numerical value collected in the Internet and a designated local network using a bot, and
when the numerical information is input through the user interface, the content providing unit generates and provides a graph for the inputted numerical information using the cube data and metadata converted by the data structure unit.

12. The numerical information management device of claim 1, further comprising:
a content sharing unit which provides the graph provided by the content providing unit through a user-specified social network services/sites (SNS), a link URL, and a download.

13. The numerical information management device of claim 1, wherein the content providing unit extracts a graph template designated by the user or a recommended graph template from the DB and applies and provides the analyzed cube data to the extracted graph template.

14. The numerical information management device of claim 12, wherein the content providing unit further includes a graph recommending unit which recommends a graph template according to the information recorded in the temporal viewpoint, the spatial viewpoint, and the user viewpoint of the extracted cube data or a unit of the numerical value.
